(19) United States
(12) Patent Application Publication
(10) Pub. No.: US 2009/0103592 A1
(43) Pub. Date: Apr. 23, 2009

(54) MYRIAD FILTER DETECTOR FOR MULTIUSER COMMUNICATION

(75) Inventors: NORMAN C. BEAULIEU, EDMONTON (CA); NIRANJAYAN SOMASUNDARAM, EDMONTON (CA)

Correspondence Address: SMART & BIGGAR;P.O. BOX 2999, STATION D, 900-55 METCALFE STREET, OTTAWA, ON, K1P 5Y6, CA

(73) Assignee: THE GOVERNORS OF THE UNIVERSITY OF ALBERTA, EDMONTON (CA)

(21) Appl. No.: 12/253,473

(22) Filed: Oct. 17, 2008

Related U.S. Application Data
(60) Provisional application No. 60/980,930, filed on Oct. 18, 2007.

(51) Int. Cl. H04B 1/69; H04B 1/10

(52) U.S. Cl. 375/138; 375/346; 375/130; 375/E01.001

(57) ABSTRACT

An adaptive receiver for multiple access communication, illustratively UWB multiple access communication, is provided. One embodiment of a detector is derived based on the finding that an symmetric alpha-stable model is more suitable for modeling the MAI in multiuser UWB systems than existing models. A myriad filter detector works better than all the known receiver structures proposed for statistical MAI cancellation. An intuitive expression for the tuning parameter K is provided which worked well in the examples considered.

### CROSS-REFERENCE TO RELATED APPLICATION

This application claims the benefit of prior U.S. Provisional Application No. 60/980,930 filed Oct. 18, 2007, hereby incorporated by reference in its entirety.

### FIELD OF THE INVENTION

The invention relates to receivers for multiuser communication such as UWB multiuser communication.

### BACKGROUND OF THE INVENTION

In many multiuser communication system studies, the multiuser interference (MUI), also called multiple-access interference (MAI), has conventionally been modeled as a Gaussian process which is justified by a central limit theorem (CLT). However, there are certain cases where the MUI cannot be approximated by a Gaussian distribution. Multiuser interference in pulse based UWB (ultra wideband) communication is one such scenario where the CLT is known to have very slow convergence even in an environment with equal power independent interferers. Several non-Gaussian models have been proposed for the MUI in the context of performance analysis and receiver design. A few models have also been proposed for the accurate statistical characterization of the MUI as a function of simple random variables (commonly functions of uniform and binomial random variables) in the additive white Gaussian noise (AWGN) channel. In general, these models may not be suitable for economical receiver design due to their complexity, although they are tractable for exact or close-to-exact bit error rate (BER) analysis.

A Laplacian model(LM), generalized Gaussian (GGM) model, Gaussian mixture model (GMM) and a hidden Markov model (HMM) have been used for approximating the distribution of the MAI. These distributions are generally heavy tailed and have a positive excess kurtosis, which is desirable because it is known that the MUI in UWB systems is impulsive. All the models mentioned are known to fit the distribution of the MAI better than the Gaussian approximation (GA).

### SUMMARY OF THE INVENTION

According to one broad aspect, the invention provides a method comprising: receiving a signal, the signal comprising a plurality of representations of an information bit, multiple-access interference from other signals, and noise; processing the received signal using a receiver that is configured to generate decision statistics based on a symmetric alpha-stable distribution assumption for the multiple-access interference and noise, to generate at least one decision statistic.

In some embodiments, the method further comprises generating a decision of a value for the information bit based on the at least one decision statistic.

In some embodiments, the signal comprises a UWB signal carrying said information bit.

In some embodiments, processing the received signal comprises: generating a plurality of samples for the information bit, each sample corresponding to a respective time-hopped representation of the bit in the desired signal; processing the plurality of samples using a first myriad filter detector to produce a first decision statistic; processing the plurality of samples using a second myriad filter detector to produce a second decision statistic; combining the first decision statistic and the second decision statistic to produce the overall decision statistic.

In some embodiments, each sample is a correlator output sample.

In some embodiments, processing the plurality of samples using a first myriad filter detector to produce a first decision statistic comprises determining:

$${\prod }_{i = 1}^{{N}_{s}} [ {K}^{2} + {( {γ}_{i , b} - s )}^{2} ]$$

processing the plurality of samples using a second myriad filter detector to produce a second decision statistic comprises determining:

$${\prod }_{i = 1}^{{N}_{s}} [ {K}^{2} + {( {γ}_{i , b} + s )}^{2} ]$$

where γ_{i,b} are the plurality of samples, K is a tuning parameter, and s represents a magnitude of a signal component.

In some embodiments, receiving a signal comprises receiving a signal comprising a plurality of information bits inclusive of said information bit; wherein the step of processing the received signal is performed for each information bit.

In some embodiments, the method further comprises adapting a value for K.

In some embodiments, adapting a value for K comprises: determining a plurality of samples of an empirical characteristic function of the multiple access interference; determining K from the plurality of samples of the empirical characteristic function.

In some embodiments, the method further comprises: approximating the characteristic function as Φ₁(ω)≅exp(−ζ|ω|^{α}), where α and ζ are parameters to be estimated; estimating α and ζ from the plurality of samples of the empirical characteristic function; using an empirical relationship for K to determine K from α and ζ.

In some embodiments, using an empirical relationship for K to determine K from α and ζ comprises using:

$${K}^{2} = {ζ}^{\frac{2}{α}} ( \frac{α}{2 - α} ) + C {σ}^{2}$$

to determine K from α and ζ, where C is a constant and σ² is variance of a noise component nᵢ.

According to another broad aspect, the invention provides an apparatus comprising: at least one antenna for receiving a signal, the signal comprising an information bit, multiple-access interference from other signals, and noise; a receiver that is configured to generate decision statistics based on a symmetric alpha-stable distribution assumption for the multiple-access interference and noise, to generate at least one decision statistic.

In some embodiments, the receiver is further configured to make a decision based on the at least one decision statistic.

In some embodiments, the receiver comprises: a sample generator that generates a set of samples for the information bit; a decision statistic generator configured to perform processing of the samples based on a symmetric alpha-stable distribution assumption for the multiple-access interference and noise to produce at least one decision statistic; and a decision generator that produces a decision of a value for the information bit based on the at least one decision statistic.

In some embodiments, the signal comprises a UWB signal carrying said information bit.

In some embodiments, the sample generator generates a respective sample for each of a plurality of time-hopped representations of the information bit in the signal; the decision statistic generator comprises: a) a first myriad filter detector configured to process the plurality samples to produce a first decision statistic; b) a second myriad filter detector configured to process the plurality of samples to produce a second decision statistic.

In some embodiments, the apparatus further comprises: a combiner that generates an overall decision statistic from the first decision statistic and the second decision statistic, the decision generator configured to make a decision based on the overall decision statistic.

In some embodiments, the first myriad filter detector produces the first decision statistic according to:

$${\prod }_{i = 1}^{{N}_{s}} [ {K}^{2} + {( {γ}_{i , b} - s )}^{2} ]$$

the second myriad filter detector produces the second decision statistic according to:

$${\prod }_{i = 1}^{{N}_{s}} [ {K}^{2} + {( {γ}_{i , b} + s )}^{2} ]$$

where γ_{i,b} are the plurality of samples, K is a tuning parameter, and s represents a magnitude of a signal component.

In some embodiments, the apparatus further comprises: a parameter estimator that estimates a value of K.

In some embodiments, the parameter estimator is configured to estimate the value of K by: determining a plurality of samples of an empirical characteristic function of the multiple access interference; determining K from the plurality of samples of the empirical characteristic function.

In some embodiments, the parameter estimator is further configured to estimate the value of K by: approximating the characteristic function as Φ₁(ω)≅exp(−ζ|ω|^{α}), where α and ζ are the parameters to be estimated; estimating α and ζ from the plurality of samples of the empirical characeristic function; using an empirical relationship for K to determine K from α and ζ.

In some embodiments, the parameter estimater uses the following empirical relationship for K

$${K}^{2} = {ζ}^{\frac{2}{α}} ( \frac{α}{2 - α} ) + C {σ}^{2}$$

to determine K from α and ζ, where C is a constant and σ² is the variance of a noise component nᵢ.

### BRIEF DESCRIPTION OF THE DRAWINGS

Embodiments of the invention will be described with reference to the attached drawings in which:

FIG. 1 contains plots of simulation results for, the actual MAI PDF, symmetric alpha-stable model PDF approximation, and various other PDF approximations;

FIG. 2 contains plots of simulation results for, the MAI PDF after smoothing, symmetric alpha-stable model PDF approximation, and various other PDF approximations;

FIG. 3 contains a comparison of the BER of a myriad detector with the BERs of a linear detector and three other non-linear detectors with Nᵤ=4;

FIG. 4 contains a comparison of the BER of the myriad detector with the BERs of the linear detector and three other non-linear detectors with Nᵤ=16;

FIG. 5 is a block diagram of a UWB receiver provided by an embodiment of the invention;

FIG. 6 is a flowchart of a method of receiving provided by an embodiment of the invention; and

FIG. 7 is a block diagram of a receiver provided by an embodiment of the invention.

### DETAILED DESCRIPTION OF THE EMBODIMENTS

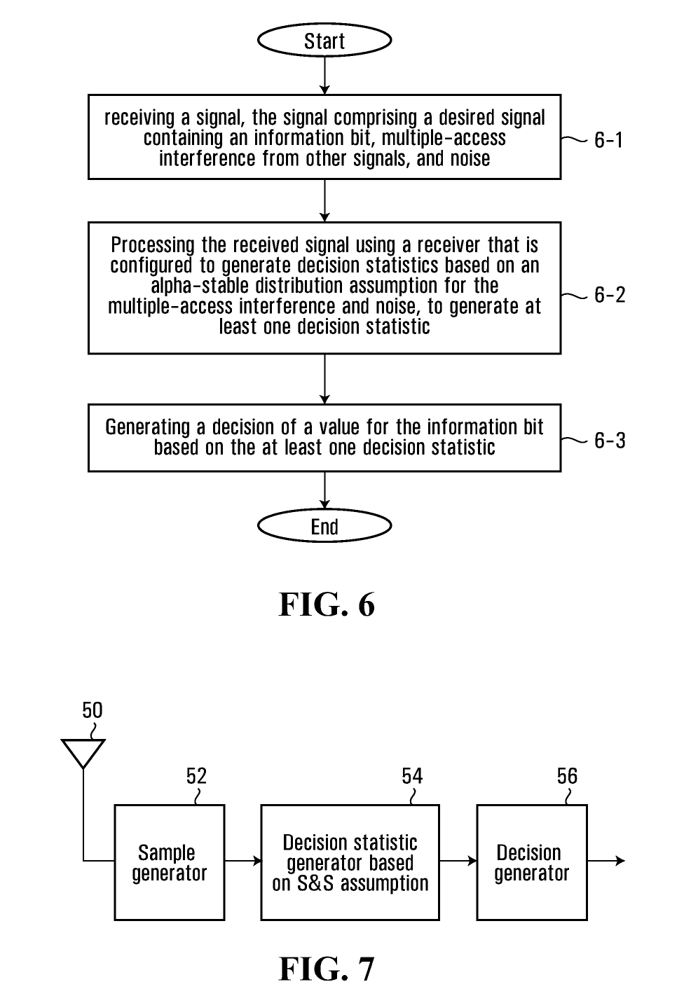

A receiver based on a symmetric alpha-stable model for the MUI is provided. Referring now to FIG. 6, shown is a flowchart of a method performed by such a receiver. The method begins at step 6-1 with receiving a signal, the signal comprising a desired signal containing an information bit, multiple-access interference (MAI) from other signals, and noise. In some embodiments, the signal is a wireless signal received over a wireless communications channel using one or more antennas. The method continues at step 6-2 with processing the received signal using a receiver that is configured to perform processing based on a symmetric alpha-stable distribution assumption for the multiple-access interference and noise to produce at least one decision statistic. In some embodiments, the receiver uses at least one approximated parameter, for example determined as a function of estimates of multiple-access interference and/or noise. The assumption that the multiple-access interference and noise has a symmetric alpha-stable distribution is a constraint on the receiver design. The actual assumption may have varying degrees of accuracy depending on the nature of the received signal which in turn may effect the accuracy of the receiver. The method continues in step 6-3 with generating a decision of a value for the information bit based on the at least one decision statistic. In some embodiments, a hard decision is not made, but rather the at least one decision statistic are used for further processing, for example, in a RAKE receiver.

In some embodiments, the at least one decision statistic is an overall statistic that is a combination of a respective decision statistic for each of two possible decisions. This can involve for example, generating a plurality of samples for the information bit, each sample corresponding to a respective time-hopped representation of the bit in the desired signal; processing the plurality of samples using a first myriad filter detector to produce a first decision statistic; processing the plurality of samples using a second myriad filter detector to produce a second decision statistic; combining the first decision statistic with the second decision to produce an overall decision statistic upon which the decision is based for example by comparing the overall decision statistic to a threshold. In another embodiment, the at least one decision statistic includes the first decision statistic and the second decision statistic, and the decision is made on the basis of the two decision statistics without first generating an overall decision statistic for example by performing a comparison operation between the two decision statistics as detailed below.

In some embodiments, each “sample” is a correlator output of a correlation operation between a portion of a received signal containing a representation of the bit with a template signal.

In some embodiments, the approximated parameter(s) is updated/adapted for each information bit. This can, for example involve adapting a value for K for each information bit as detailed below. Alternatively, the approximated parameter(s) can be adapted on some other basis, for example periodically, for example after each set of N_{adapt} bits, where N_{adapt} is the adaptation period, in bits, or on some other basis.

An apparatus configured to implement the above-described method is shown in FIG. 7. The apparatus has an antenna 50 (more generally at least one antenna) for receiving a signal, the signal comprising a desired signal containing an information bit, multiple-access interference from other signals, and noise. There is sample generator 52 that generates a set of samples for the information bit. A decision statistic generator 54 is configured to perform processing of the samples based on a symmetric alpha-stable distribution assumption for the multiple-access interference and noise to produce at least one decision statistic. A decision generator 56 produces a decision of a value for the information bit based on the at least one decision statistic.

### DETAILED EXAMPLES

The transmitted signal of the k^{th} user in a TH-UWB (time-hopped UWB) system with pulse amplitude modulation (PAM) can be written as

$${s}^{k} ( t ) = \sqrt{{E}_{s} / {N}_{s}} {\sum }_{i = - ∞}^{∞} {d}_{⌊ i / {N}_{s} ⌋} p ( t - {iT}_{f} - {c}_{i}^{k} {T}_{c} )$$

where p(t) is the transmitted UWB pulse with unit energy, Eₛ is the energy of a symbol, and T_{f} is the length of a frame. One symbol consists of Nₛ pulses and hence a symbol duration is equal to NₛT_{f}. The b^{th} transmitted data symbol is denoted by d_{b} where d_{b} can be −1 or +1 and └x┘denotes the largest integer not greater than x. The time-hopped sequence is denoted by cᵢ^{k}ε{0,1, . . . Nₕ}, where the integer Nₕ satisfies the condition NₕT_{c}≦T_{f}, and T_{c} is the TH step size. Assuming that the system contains Nᵤ active asynchronous users the received signal can be written as

$$r ( t ) = {\sum }_{k = 0}^{{N}_{u} - 1} {h}^{k} {s}^{k} ( t - {τ}^{k} ) + n ( t ) \qquad ( 1 )$$

where h^{k} and τ^{k} are respectively the channel gain and the asynchronous delay of the k^{th} user, and n(t) is additive white Gaussian noise (AWGN) from the channel. Assuming h⁰=1 the sample generated by a correlation receiver can be written as

$$\begin{matrix}\begin{matrix}{γ}_{b} = {\sum }_{i = {bN}_{s}}^{( b + 1 ) {N}_{s} - 1} {\int }_{{iT}_{f} + {c}_{i}^{0} {T}_{c} + {τ}_{0}}^{( i + 1 ) {T}_{f} + {c}_{i}^{0} {T}_{c} + {τ}_{0}} r ( t ) p ( t - {iT}_{f} - {c}_{i}^{0} {T}_{c} - {τ}_{0} ) d t \\ = {\sum }_{i = {bN}_{s}}^{( b + 1 ) {N}_{s} - 1} {γ}_{i , b} \\ = {d}_{b} S + I + n\end{matrix} & ( 2 ) \\ {γ}_{i , b} = {\int }_{{iT}_{f} + {c}_{i}^{0} {T}_{c} + {τ}_{0}}^{( i + 1 ) {T}_{f} + {c}_{i}^{0} {T}_{c} + {τ}_{0}} r ( t ) p ( t - {iT}_{f} - {c}_{i}^{0} {T}_{c} - {τ}_{0} ) d t & ( 3 )\end{matrix}$$

and it is assumed that the b^{th} bit of the 0^{th} user is being detected. The signal component S in (2) is given by \sqrt{EₛNₛ} and n denotes the filtered Gaussian noise. The MAI component I can be written as

$$I = {\sum }_{i = {bN}_{s}}^{( b + 1 ) {N}_{s} - 1} {\int }_{{iT}_{f} + {c}_{i}^{0} {T}_{c} + {τ}_{0}}^{( i + 1 ) {T}_{f} + {c}_{i}^{0} {T}_{c} + {τ}_{0}} {\sum }_{k = 1}^{{N}_{u} - 1} {h}^{k} {s}^{k} ( t - {τ}^{k} ) p ( t - {iT}_{f} - {c}_{i}^{0} {T}_{c} - {τ}_{0} ) d t . \qquad ( 4 )$$

Similarly, one can express the partial correlation from a single frame, γ_{i,b}, as γ_{i,b}=d_{b}sᵢ+Iᵢ+nᵢ where sᵢ=s=\sqrt{Eₛ/Nₛ}, and where Iᵢ is given by

$${I}_{i} = {\int }_{{iT}_{f} + {c}_{i}^{0} {T}_{c} + {τ}_{0}}^{( i + 1 ) {T}_{f} + {c}_{i}^{k} {T}_{c} + {τ}_{0}} {\sum }_{k = 1}^{{N}_{u} - 1} {h}^{k} {s}^{k} ( t - {τ}^{k} ) p ( t - {iT}_{f} - {c}_{i}^{0} {T}_{c} - {τ}_{0} ) d t \qquad ( 5 )$$

and

$$E \{ {n}_{i}^{2} \} = {N}_{0} / 2 {\int }_{0}^{{T}_{f}} {p ( t )}^{2} d t = {N}_{0} / 2$$

where N₀/2 is the two-sided power spectral density of the AWGN.

A new UWB receiver is provided which is based on the assumption that the MAI has a symmetric alpha-stable distribution.

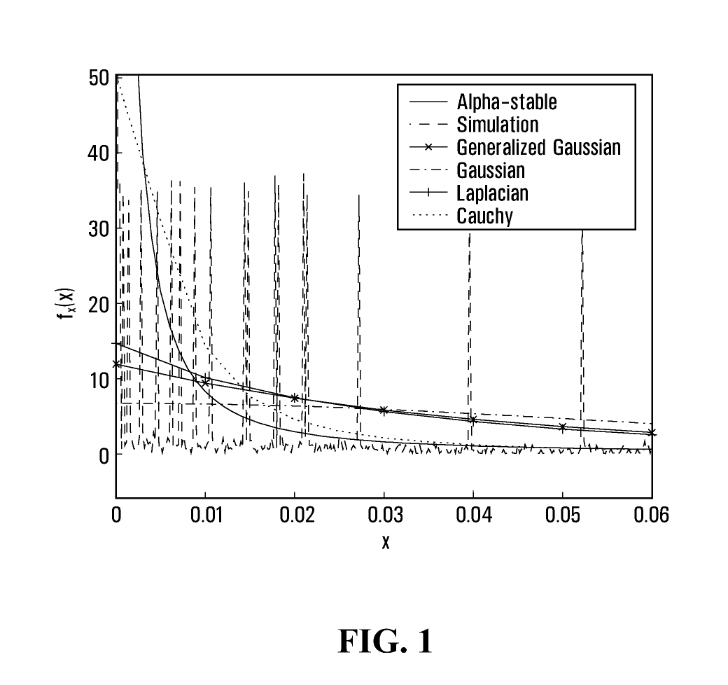

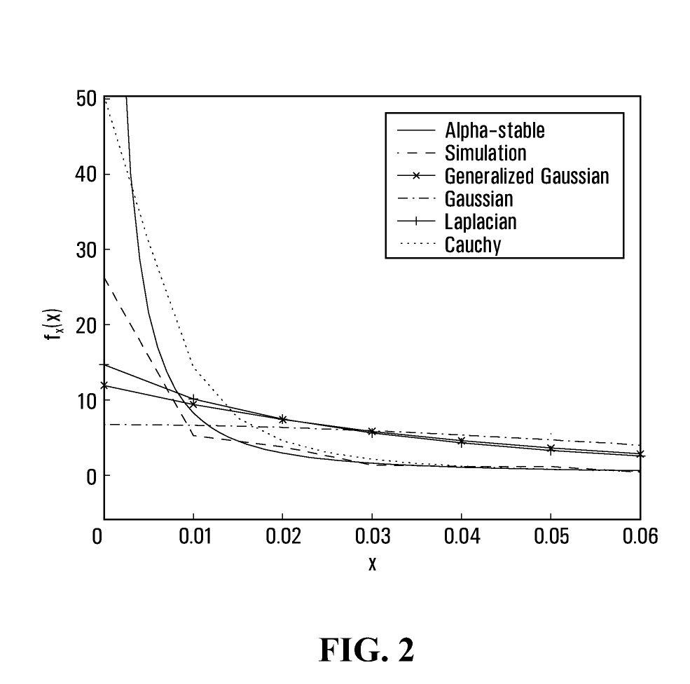

In order to construct a symmetric alpha-stable model for the UWB MUI, it will be useful to first consider an adaptation of an empirical probability density function (PDF) of the MUI as determined by simulation. The rationale for this adaptation is the following. Any estimate of the actual PDF of the MAI by simulation is an estimate of a locally averaged version of the actual PDF. Let f_{I}^{a} (I) denote the actual PDF of the MAI, I, and f_{I}^{s} (I) denote a PDF estimate by simulation, we can write E{f_{I}^{s}(x)}=P_{I}^{a}(x−δ<I<x+δ)/2δ, where 2δ denotes the length of a small segment in the x axis. In FIG. 1, several known PDF approximations are compared with the actual PDF of the MAI. Finding f_{I}^{a}(I) analytically is difficult. Therefore, an accurate estimate of f_{I}^{a}(I) is obtained by simulations with a smaller value of δ. It is difficult to draw conclusions on the suitability of the PDF models from FIG. 1 because f_{I}^{a}(I) has several singularities which make finding a PDF model difficult. Therefore, in finding a PDF model we make use of the locally averaged PDF f_{I}^{s}(I) instead of the actual PDF f_{I}^{a}(I). In FIG. 2, the parameter δ has been adjusted until f_{I}^{s}(x) becomes smooth enough for a meaningful graphical comparison with the other known PDFs which are all smooth functions. Among the various models compared, the symmetric alpha-stable PDF model fits well with the locally averaged PDF f_{I}^{s}(I). In FIGS. 1 and 2, the parameter values used are Nₛ=8, Nₕ=8 , T_{f}=20 , T_{c}=0.9, τₘ=0.575 and Nᵤ=16. A causal 2^{nd}-order Gaussian monocycle is used for p(t). Second order moments are matched to find the Gaussian and Laplacian fits, the kurtosis matching technique is used for the GGM, the 0.5^{th} order fractional lower order moment (FLOM) is used to find the scaling parameter of the Cauchy distribution and the symmetric alpha-stable model parameters are calculated using the technique described below.

It is noted that a PDF with singularities is difficult to capture with a simple mathematical model. However, the area under singularities are small, hence considering a smoothed PDF will not be much different from considering the PDF with singularities for detection purposes. Locally averaging also occurs in the receiver due to filtering, sampling and quantizing.

A symmetric alpha-stable RV, Z, has the following characteristic function

Φ_{Z}(ω)=exp(−ζ|ω|^{a}+jωβ)0≦α≦2 (6)

where α is the characteristic exponent which determines the heaviness of the tail of the PDF of Z, ζ is the shaping parameter, and β is the location parameter of the distribution. The location parameter is the mean of the random variable, or the point where the PDF is symmetric on both sides. In this case it is the signal that is to be detected and as such, the location parameter is the same as the signal level. One can note that both the Gaussian distribution and the Cauchy distribution are special cases of the symmetric alpha-stable distribution with α=2 and α=1, respectively. Also, a larger value of α represents a smooth (or non-impulsive distribution) and a smaller value of α represents a heavy tailed (impulsive) distribution. Note that closed-form expressions for the corresponding PDFs are only known for the cases α=0.5, α=1 and α=2. Even though one can express the PDF for αε[0,1)∪(1,2) in series expansions, the resulting expressions are not well suited for the purpose of receiver design.

In accordance with an embodiment of the invention, a myriad filter location estimator is adapted for use in an adaptive receiver, for application, for example, to UWB signals. A myriad filter location estimator is used to estimate the location parameter, β, of a symmetric alpha-stable distribution. Based on an observation set (or samples) {xᵢ}ᵢ₌₁^{N} the myriad filter location estimator's estimate of the location is given by

$$\hat{β} = myriad [ K ; {x}_{1} , {x}_{2} , … , {x}_{N} ] = {argmin}_{β} {\prod }_{i = 1}^{N} [ {K}^{2} + {( {x}_{i} - β )}^{2} ] \qquad ( 7 )$$

where one has to select a suitable value of K known as the tuning or linearity parameter. In some embodiments, K is selected using an α˜K relationship that attempts to minimize detection error probability.

If the problem is binary signal detection with perfect channel information, the location parameter β is restricted such that βε{−s,s} where s represents the magnitude of the signal component in the decision variable. A myriad filter location estimator for binary detection is provided according to

$$\hat{β} = {argmin}_{β ∈ \{ - s , s \}} {\prod }_{i = 1}^{{N}_{s}} [ {K}^{2} + {( {γ}_{i , b} - β )}^{2} ] \\ and \\ \hat{β} = s ⇒ {d}_{b} = 1 , \hat{β} = - s ⇒ {d}_{b} = - 1. \qquad ( 8 )$$

The decision rule is to test

$${\prod }_{i = 1}^{{N}_{s}} [ {K}^{2} + {( {γ}_{i , b} - s )}^{2} ] \frac{<}{>} {\prod }_{i = 1}^{{N}_{s}} [ {K}^{2} = {( {γ}_{i , b} + s )}^{2} ] \qquad ( 9 )$$

using a suitable value of K.

By adapting K over time, for example as detailed below, Equation (9) can be used to implement an adaptive receiver rule for detection of signals contaminated by symmetric alpha-stable noise. Now, one can note that the distribution of the term Iᵢ+nᵢ in (2) can be more closely approximated by a Gaussian distribution in the following cases, when E{nᵢ²} is dominant, or when there is a large number of interferers, or when Iᵢ is weak. On the other hand, it can be closely approximated (see FIG. 2) by an symmetric alpha-stable distribution with α<2 when Iᵢ is strong and originates from a small-to-moderate number of interferers and/or E{nᵢ²} is small. For example, this approach might be particularly appropriate for 5 to 20 interferers. However, it may prove effective outside this range as well. In some embodiments, the parameter K is adapted to make the receiver adaptive to conditions such as:

dominance of E{nᵢ²};

number of interferers;

strength of Iᵢ.

In some embodiments, the following empirical relationship for K is employed:

$${K}^{2} = {ζ}^{\frac{2}{α}} ( \frac{α}{2 - α} ) + C {σ}^{2} \qquad ( 10 )$$

where C is a constant, which might be experimentally determined for example, and σ² is the variance of nᵢ and α and ζ are parameters to be approximated. It is noted that this is an empirical relationship, and that other relationships for K may alternatively be used. This particular expression does not represent an optimal solution. The data bit d_{b} is detected as

$${d}_{b} = sign [ {\prod }_{i = 1}^{{N}_{s}} [ {K}^{2} + {( {γ}_{i , b} + s )}^{2} ] - {\prod }_{i = 1}^{{N}_{s}} [ {K}^{2} + {( {γ}_{i , b} - s )}^{2} ] ] \qquad ( 11 )$$

while using the expression in eq. (10) for K².

The characteristic function (CF) of the MAI (Iᵢ) is defined by E{e^{jωI}^{ᵢ}} (where ω is the domain variable of the CF) The empirical characteristic function is an estimate of E{e^{jωI}^{ᵢ}} based on M noisy samples of Iᵢ, namely ({Īᵢ^{j}}ⱼ₌₁^{M}), where Īᵢ^{j}=Iᵢ^{j}+nᵢ^{j}. The empirical CF of Iᵢ is given by

$$( \frac{1}{M} {\sum }_{j = 1}^{M} {e}^{jω {I}_{i}^{j}} ) / {e}^{\frac{{σ}^{2} {ω}^{2}}{2}}$$

where

$${e}^{\frac{{σ}^{2} {ω}^{2}}{2}}$$

is the CF of nᵢ. Noisy samples of Iᵢ may, for example, be obtained by subtracting s or −s from the samples γ_{i,b}. Samples of Īᵢ can, for example, be collected over many symbols during a pilot sequence transmission.

The samples are referred to as “noisy samples” because it is difficult to sample Iᵢ alone. In practical situations, samples of Iᵢ+nᵢ can be obtained, where nᵢ is an AWGN component. While Iᵢ is referred to in the above, based on the assumption that the MAI in each frame is identically distributed, the calculations do not need to be repeated for all i, and the values of α and ζ determined, and ultimately the value of K determined, are applicable for all i over an adaptation period.

In some embodiments, in order to estimate the parameters α and ζ, the empirical CF is calculated over N_{ω} equally spaced sample points of ω given by the vector ω={Δω, . . . , Ω} where Δω=Ω/N_{ω}. The CF of Iᵢ is now approximated by

Φ_{I}_{ᵢ}(ω)≅exp(−ζ|ω|^{α}) (12)

where α and ζ are the parameters to be estimated. By taking natural logarithms twice on both sides of (12) the following linear relation is obtained

ln(−ln(Φ_{I}_{ᵢ}(ω)))≅ln(ζ)+αln(ω) for ω>0. (13)

If In(−ln(Φ_{I}_{ᵢ}(ω)))=a₁+a₂ ln(ω), the least square error (LSE) linear fit for the data points ln(ω) vs. ln(−ln(ω))), then estimates for α and ζ can be made as follows:

α=a₂ and

ζ=e^{a}^{₁}.

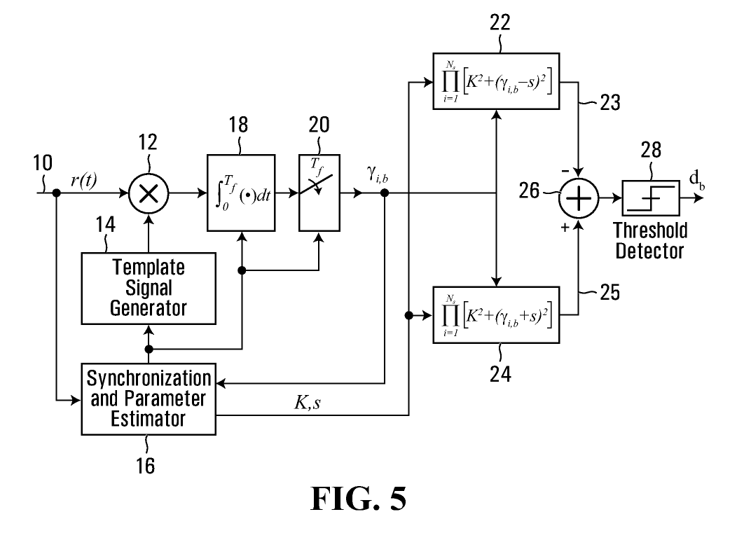

A block diagram of an example implementation of a UWB receiver is shown in FIG. 5. A received signal r(t) 10 is multiplied by the output of a template signal generator 14 with multiplier 12. The output is integrated over the pulse period by integrator 18, and sampled at a sampling instant with sampler 20 to produce γ_{i,b}. The received signal 10 is also input to synchronization and parameter estimator 16. Synchronization is performed to, for example,determine the sampling instance, and integration period. The synchronization and parameter estimator 16 also receives γ_{i,b}. Parameter estimation involves estimating parameters such as K and s. The parameter s might be estimated by averaging samples of γ_{i,b} collected over many symbols during a pilot (training) sequence transmission, for example, or by some other estimation method. Synchronization and parameter estimation may be implemented in separate components.

The parameters K and s, and the correlator outputs γ_{i,b} are fed into myriad filter calculators 22 and 24 which produce respective outputs 23, 25 corresponding to each possible value of the bit being estimated. The parameter “+s” and “−s” in the two myriad filter calculators 22, 24 represent the two possible values for the signal. The difference between outputs 23, 25 is produced in adder 26, and thresholding is performed based on this difference in threshold detector 28.

In FIG. 5, elements 12, 14, 18, 20, 22, 24, 26 collectively comprise a sample generator. Other implementations are possible, and may for example depend on the particular form of the UWB signal being detected. In general, the sample generator produces a respective sample for each of a plurality of time-hopped representations of the bit in the desired UWB signal. The element 28 comprises a decision generator. Other implementations are possible.

The specific examples described herein relate to time-hopping binary phase shift keying (TH-BPSK). However, the analysis and results are similar for a binary pulse position modulation (PPM) scheme and other binary schemes using an appropriate template.

The detailed examples above assume the myriad filter detector receiver approach is applied to the reception of a UWB signal. In some embodiments, the UWB signals are as defined in some literature to be any signal having a signal bandwidth that is greater than 20% of the carrier frequency, or a signal having a signal bandwidth greater than 500 MHz. In some embodiments, the myriad filter detector approach is applied to signals having a signal bandwidth greater than 15% of the carrier frequency. In some embodiments, the myriad filter detector receiver approach is applied to signals having pulses that are 1 ns in duration or shorter. These applications are not exhaustive nor are they mutually exclusive. For example, many UWB signals satisfying the above literature definition will also feature pulses that are 1 ns in duration or shorter.

The myriad filter detector receiver approach is applied to signals for which a plurality of correlations are to be performed in a receiver. In a specific example, the method might be applied for a plurality of correlations determined by the repetition code in a UWB receiver.

### Numerical Results

TABLE I
Detectors based on different MAI models

| | | | Parameter |
|---|---|---|---|
| | | | Estimation |
| Detector | Model | Decision metric Δ | method |
| Linear | ${f}_{{I}_{i}} ( x ) = \frac{1}{\sqrt{2 π} ζ} {e}^{- {x}^{2} / 2 {ζ}^{2}}$ | ${\sum }_{i = 1}^{{N}_{s}} {γ}_{i , b}$ | None |
| Cauchy | ${f}_{{I}_{i} + {n}_{i}} ( x ) = \frac{ζ}{π ( {x}^{2} + {ζ}^{2} )}$ | ${\prod }_{i = 1}^{{N}_{s}} [ {ζ}^{2} + {( {γ}_{i , b} + s )}^{2} ] - {\prod }_{i = 1}^{{N}_{s}} [ {ζ}^{2} + {( {γ}_{i , b} - s )}^{2} ]$ | FLOMmatching |
| SGLM | ${f}_{{I}_{i}} ( x ) = \frac{1}{2 ζ} {e}^{- \vert x \vert / ζ}$ | ${\sum }_{i = 1}^{{N}_{s}} \vert \frac{m {γ}_{i , b}}{2} + \frac{s}{ζ} \vert - \vert \frac{m {γ}_{i , b}}{2} - \frac{s}{ζ} \vert$ | 2^{nd} momentmatching |
| GGM | ${f}_{{I}_{i}} ( x ) = \frac{α}{2 ζΓ ( {α}^{- 1} )} {e}^{- {\vert x / ζ \vert}^{α}}$ | ${\sum }_{i = 1}^{{N}_{s}} {\vert {γ}_{i , b} + s \vert}^{α} / {ζ}^{α} - {\vert γ i , b - s \vert}^{α} / {ζ}^{α}$ | kurtosismatching |
| Symmetricalpha-stable | Φ_{I}_{ᵢ} (ω) = exp(−ζ\|ω\|^{α}) | ${\prod }_{i = 1}^{{N}_{s}} [ {K}^{2} + {( {γ}_{i , b} + s )}^{2} ] - {\prod }_{i = 1}^{{N}_{s}} [ {K}^{2} + {( {γ}_{i , b} - s )}^{2}$ | EmpiricalCF |

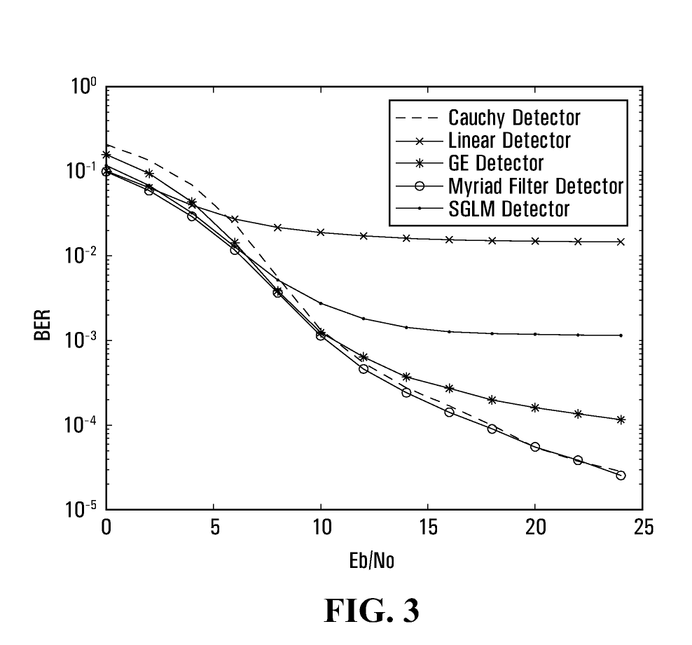

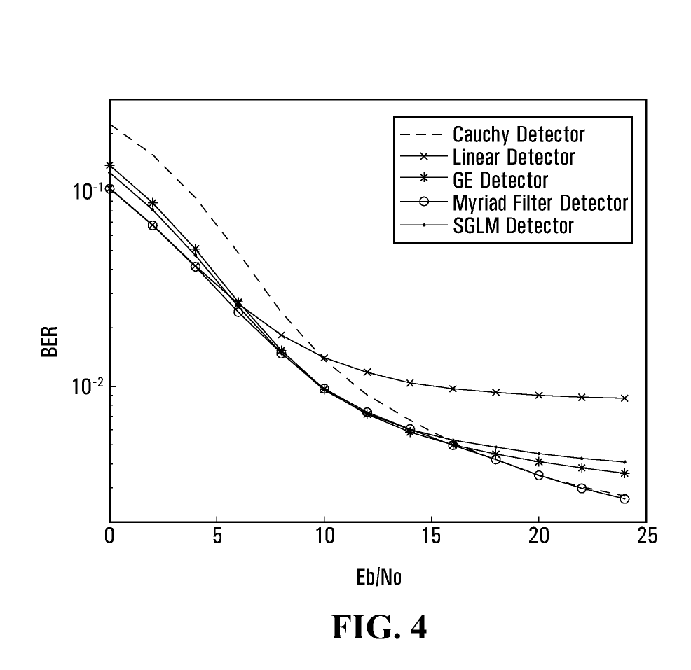

Values of BER are compared for the following set of parameters, Nₛ=8, Nₕ=8, T_{f}=20, T_{c}=0.9, τₘ=0.575 and Nᵤ=4or 16. A 2nd-order Gaussian monocycle is used for signaling and the SIR is set at 10 dB. Table I shows a comparison of the different detectors. In Table I, ζ denotes the scaling parameter and α denotes the shaping parameter of the distribution models. In the Cauchy receiver a FLOM of order 0.5 is used to estimate the parameter ζ. The simplified Gaussian-Laplacian mixed model receiver (SGLM) uses a Laplacian model for the MAI and is adaptive to the current ambient noise level. In FIG. 3, C is set at 100 and in FIG. 4 it is set at 50. It is evident from the figures that the myriad filter detector performs significantly better than the Linear, Cauchy, GE and SGLM receivers. Although the Cauchy receiver performs closer to the myriad filter detector at large E_{b}/N₀ ratios, its performance is inferior at smaller E_{b}/N₀ ratios.

Numerous modifications and variations of the present invention are possible in light of the above teachings. It is therefore to be understood that within the scope of the appended claims, the invention may be practiced otherwise than as specifically described herein.

It should also be appreciated that the foregoing description and the drawings referenced therein are intended solely for the purposes of illustration. For example, different results than those shown in FIGS. 1 to 4 may be observed under different test or usage conditions. In the context of an apparatus, an implementation of the techniques disclosed herein may include further, fewer, or different components interconnected in a similar or different manner than shown in FIG. 5.

1. A method comprising:
receiving a signal, the signal comprising a plurality of representations of an information bit, multiple-access interference from other signals, and noise;
processing the received signal using a receiver that is configured to generate decision statistics based on a symmetric alpha-stable distribution assumption for the multiple-access interference and noise, to generate at least one decision statistic.

2. The method of claim 1 further comprising:
generating a decision of a value for the information bit based on the at least one decision statistic.

3. The method of claim 1, wherein the signal comprises a UWB signal carrying said information bit.

4. The method of claim 1 wherein:
processing the received signal comprises:
generating a plurality of samples for the information bit, each sample corresponding to a respective time-hopped representation of the bit in the desired signal;
processing the plurality of samples using a first myriad filter detector to produce a first decision statistic;
processing the plurality of samples using a second myriad filter detector to produce a second decision statistic;
combining the first decision statistic and the second decision statistic to produce the overall decision statistic.

5. The method of claim 4 wherein each sample is a correlator output sample.

6. The method of claim 4 wherein:
processing the plurality of samples using a first myriad filter detector to produce a first decision statistic comprises determining:
$${\prod }_{i = 1}^{{N}_{s}} [ {K}^{2} + {( {γ}_{i , b} - s )}^{2} ]$$
processing the plurality of samples using a second myriad filter detector to produce a second decision statistic comprises determining:
$${\prod }_{i = 1}^{{N}_{s}} [ {K}^{2} + {( {γ}_{i , b} + s )}^{2} ]$$
where γ_{i,b} are the plurality of samples, K is a tuning parameter, and s represents a magnitude of a signal component.

7. The method of claim 6 wherein:
receiving a signal comprises receiving a signal comprising a plurality of information bits inclusive of said information bit;
wherein the step of processing the received signal is performed for each information bit.

8. The method of claim 7 further comprising adapting a value for K.

9. The method of claim 8 wherein adapting a value for K comprises:
determining a plurality of samples of an empirical characteristic function of the multiple access interference;
determining K from the plurality of samples of the empirical characteristic function.

10. The method of claim 9 further comprising:
approximating the characteristic function as Φ_{I}(ω)≅exp(−ζ|ω|^{α}), where α and ζ are parameters to be estimated;
estimating α and δ from the plurality of samples of the empirical characteristic function;
using an empirical relationship for K to determine K from α and δ.

11. The method of claim 10 wherein using an empirical relationship for K to determine K from α and ζ comprises using:
$${K}^{2} = {ζ}^{\frac{2}{α}} ( \frac{α}{2 - α} ) + C {σ}^{2}$$
to determine K from α and ζ, where C is a constant and σ² is variance of a noise component nᵢ.

12. An apparatus comprising:
at least one antenna for receiving a signal, the signal comprising an information bit, multiple-access interference from other signals, and noise;
a receiver that is configured to generate decision statistics based on a symmetric alpha-stable distribution assumption for the multiple-access interference and noise, to generate at least one decision statistic.

13. The apparatus of claim 12 further configured to make a decision based on the at least one decision statistic.

14. The apparatus of claim 12 wherein the receiver comprises:
a sample generator that generates a set of samples for the information bit;
a decision statistic generator configured to perform processing of the samples based on a symmetric alpha-stable distribution assumption for the multiple-access interference and noise to produce at least one decision statistic; and
a decision generator that produces a decision of a value for the information bit based on the at least one decision statistic.

15. The apparatus of claim 14, wherein the signal comprises a UWB signal carrying said information bit.

16. The apparatus of claim 14 wherein:
the sample generator generates a respective sample for each of a plurality of time-hopped representations of the information bit in the signal;
the decision statistic generator comprises:
a) a first myriad filter detector configured to process the plurality of samples to produce a first decision statistic;
b) a second myriad filter detector configured to process the plurality of samples to produce a second decision statistic.

17. The apparatus of claim 16 further comprising:
a combiner that generates an overall decision statistic from the first decision statistic and the second decision statistic, the decision generator configured to make a decision based on the overall decision statistic.

18. The apparatus of claim 16 wherein:
the first myriad filter detector produces the first decision statistic according to:
$${\prod }_{i = 1}^{{N}_{s}} [ {K}^{2} + {( {γ}_{i , b} + s )}^{2} ]$$
the second myriad filter detector produces the second decision statistic according to:
$${\prod }_{i = 1}^{{N}_{s}} [ {K}^{2} + {( {γ}_{i , b} + s )}^{2} ]$$
where γ_{i,b} are the plurality of samples, K is a tuning parameter, and s represents a magnitude of a signal component.

19. The apparatus of claim 18 further comprising:
a parameter estimator that estimates a value of K.

20. The apparatus of claim 19 wherein the parameter estimator is configured to estimate the value of K by:
determining a plurality of samples of an empirical characteristic function of the multiple access interference;
determining K from the plurality of samples of the empirical characteristic function.

21. The apparatus of claim 20 wherein the parameter estimator is further configured to estimate the value of K by:
approximating the characteristic function as Φ_{I}(ω)≅exp(−ζ|ω|^{α}), where α and ζ are the parameters to be estimated;
estimating α and ζ from the plurality of samples of the empirical characeristic function;
using an empirical relationship for K to determine K from αand.

22. The apparatus of claim 21 wherein the parameter estimater uses the following empirical relationship for K
$${K}^{2} = {ζ}^{\frac{2}{α}} ( \frac{α}{2 - α} ) + C {σ}^{2}$$
to determine K from α and ζ, where C is a constant and σ² is the variance of a noise component nᵢ.
